(19) United States
(12) Patent Application Publication
(10) Pub. No.: US 2010/0332354 A1
(43) Pub. Date: Dec. 30, 2010

(54) Verifying identities

(76) Inventor: Ethan Eyre, Rancho Cucamonga, CA (US)

Correspondence Address: DAVID LEWIS, 1250 AVIATION AVE., SUITE 200B, SAN JOSE, CA, 95110, US

(21) Appl. No.: 12/590,853

(22) Filed: Nov. 12, 2009

Related U.S. Application Data
(63) Continuation of application No. 11/224,860, filed on Sep. 13, 2005, now abandoned.

(51) Int. Cl. G09F 7/00; G06Q 30/00; G06F 15/16

(52) U.S. Cl. 705/27.1; 40/584; 709/217

(57) ABSTRACT

A sign is sent to a user of a system. Depending upon whether there is an indication received that the sign went to an address that is not associated with the user a level of authenticity is established. The sign may be associated with a product (e.g., a good or a service). Nonetheless, the sign may be sent prior to associating the sign with the product. Other forms of verifying the authenticity of the user, such as by conducting an in-person meeting and/or performing an online verification. The other forms of verifying the authenticity of the user may be performed in together with or instead of sending the sign. A code is used having a portion representing a geographic location and a portion representing a product type. The code may be used together with or separate from the forms of verifying the user's information.

### CLAIM OF PRIORITY

This application is a continuation of U.S. patent application Ser. No. 11/224,860 entitled “VERIFYING IDENTITIES”, by Ethan Eyre, filed Sep. 13, 2005 (Attorney Docket No.: 17-1), the entire contents of which are incorporated herein by reference.

### FIELD

This application is related to verifying identities of users of a system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subjection matter in the background section merely represents different approaches, which in and of themselves may also be inventions.

In today's Internet online business models, people register and become members of many different types of websites and online venues, including e-commerce platforms, auction sites, dating sites, content related venues, media platforms and many other online sites. It is often desirable to know the identity of the users or members of a particular website. Online venues often collect information using a registration form or sign-up process, which is completed by the user before becoming a member or registered member of the website. One manner of verifying identities of users is by an online Credit Card verification or by matching personal information with banking account numbers online.

### BRIEF DESCRIPTION

In the following drawings like reference numbers are used to refer to like elements. Although the following figures depict various examples of the invention, the invention is not limited to the examples depicted in the figures.

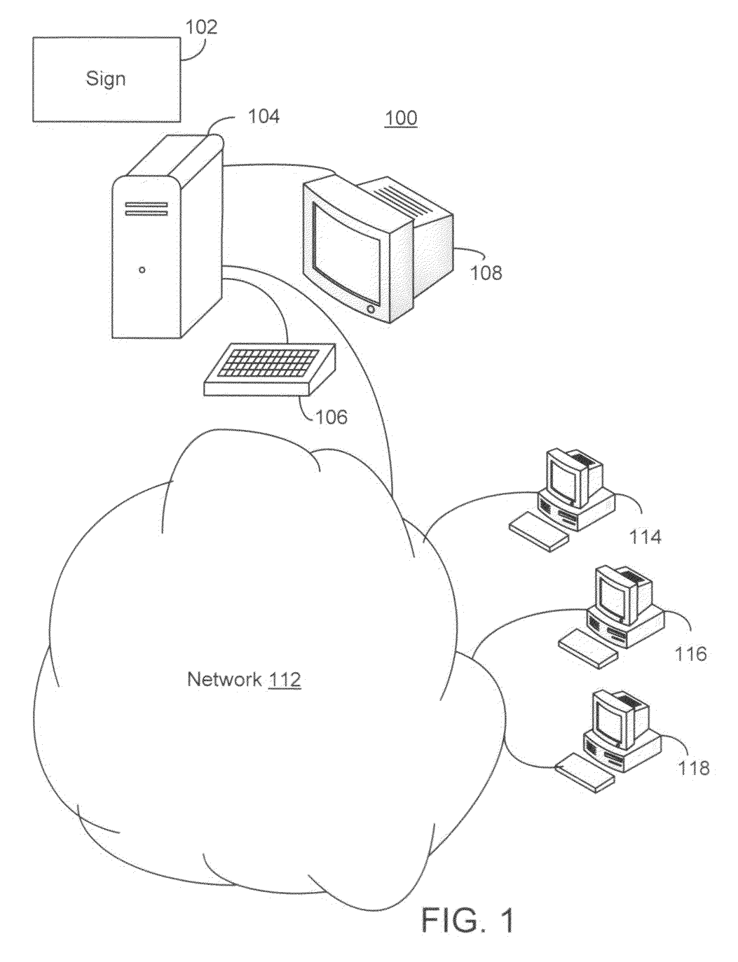

FIG. 1 shows a block diagram of a system for interacting with people online.

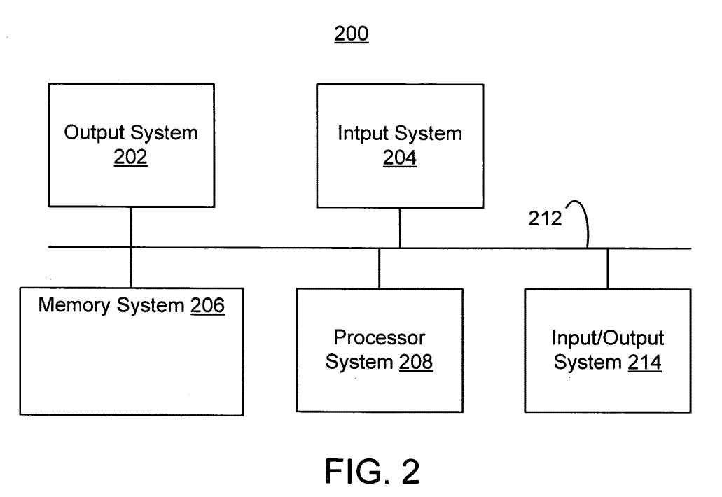

FIG. 2 shows a block diagram of a machine used in the system of FIG. 1.

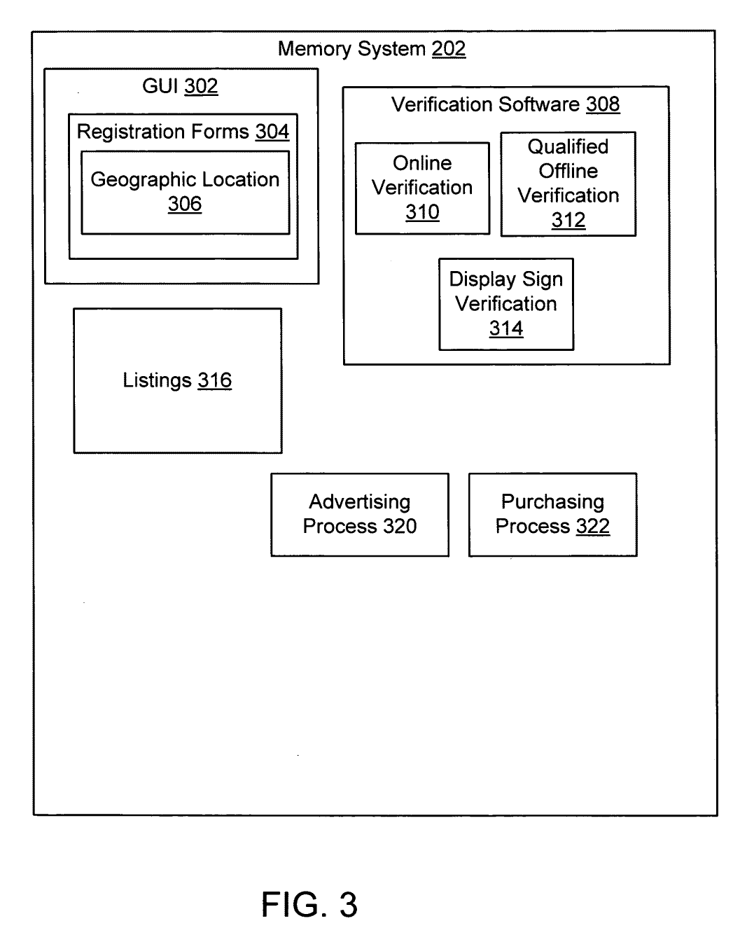

FIG. 3 shows an example of memory system of a website host of the system of FIG. 1.

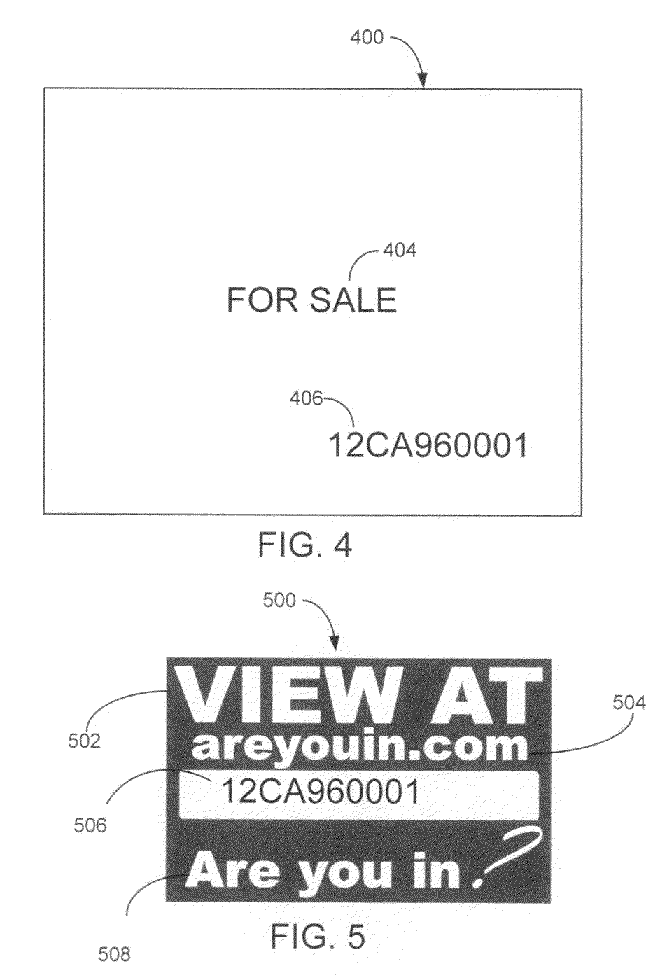

FIG. 4 shows an example of the sign that may be used in the system of FIG. 1.

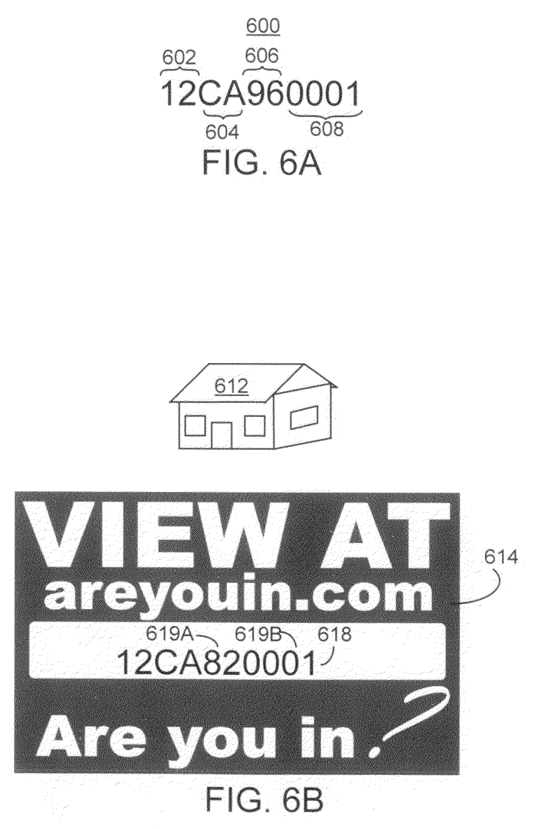

FIG. 5 shows another example of the sign used in the system of FIG. 1.

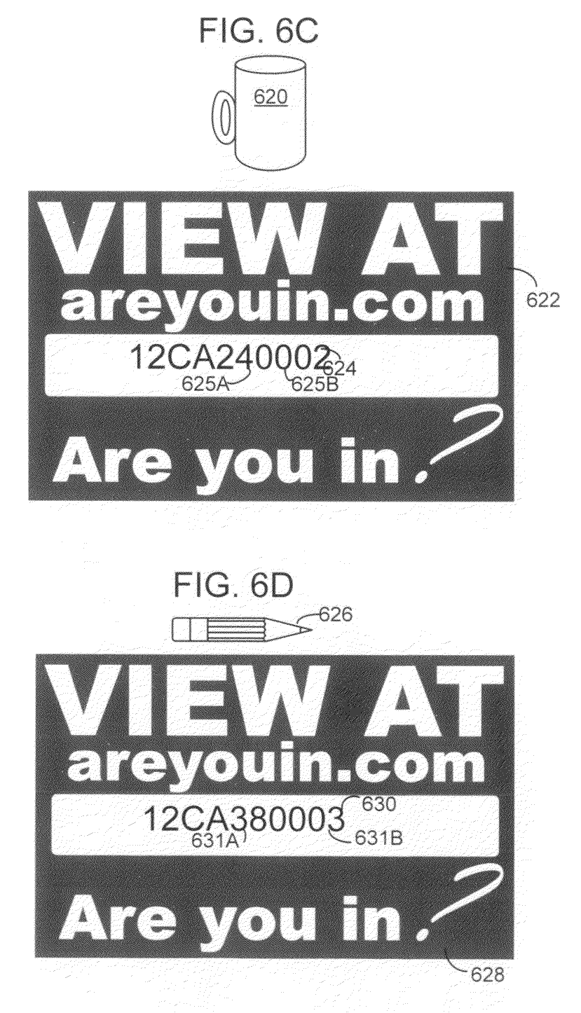

FIG. 6A shows an example of a code placed on the display sign of FIGS. 1, 4, and 5.

FIGS. 6B-D show examples of combinations of products, signs, and codes.

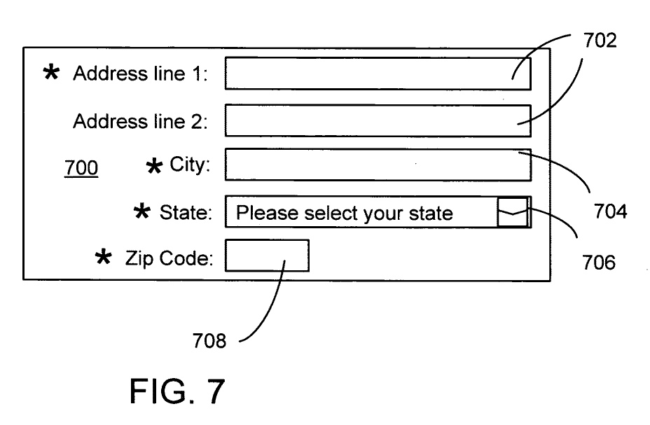

FIG. 7 shows an example of geographic location of FIG. 3.

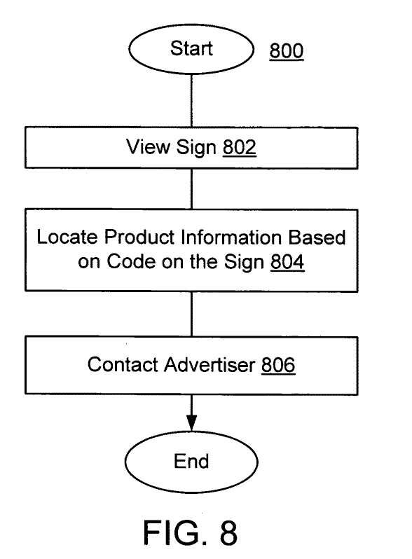

FIG. 8 shows a flowchart of an example of a method of purchasing a product using system.

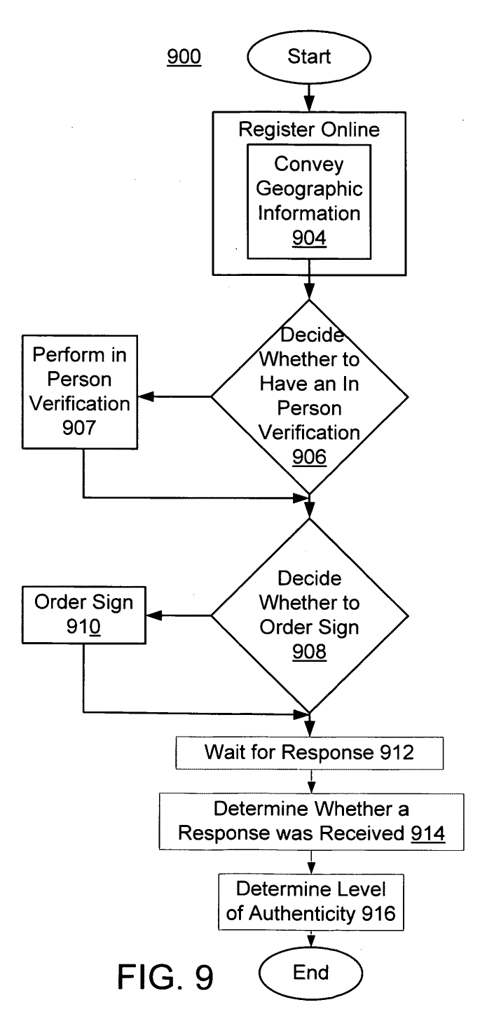

FIG. 9 shows a flowchart of an example of a method of verifying (e.g., registering) a user.

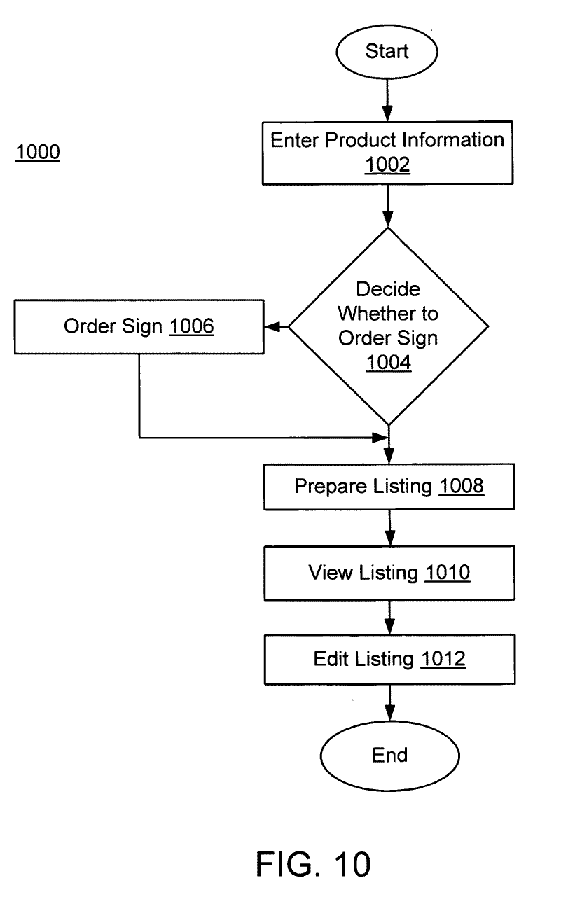

FIG. 10 shows a flowchart of an example of a method for advertising a product.

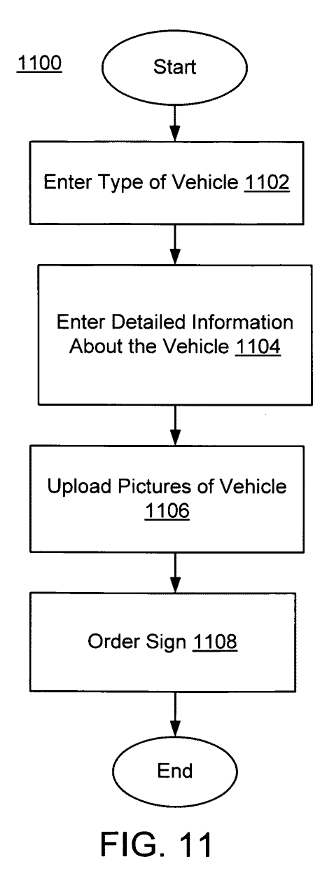

FIG. 11 shows a flowchart of and example of a method for selling cars.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies that may be discussed in the specification, and some embodiments may not address any of these deficiencies.

In general, at the beginning of the discussion of each of FIGS. 1-6A and 7 is a brief description of each element, which may have no more than the name of each of the elements in the one of FIGS. 1-6 A and 7 that is being discussed. After the brief description of each element, each element is further discussed in numerical order. In general, each of FIGS. 1-11 is discussed in numerical order and the elements within FIGS. 1-11 are also usually discussed in numerical order to facilitate easily locating the discussion of a particular element. Nonetheless, there is no one location where all of the information of any element of FIGS. 1-11 is necessarily located. Unique information about any particular element or any other aspect of any of FIGS. 1-11 may be found in, or implied by, any part of the specification.

FIG. 1 shows a block diagram of a system 100 for interacting with people online. System 100 may include sign 102, website host 104, input device 106, output device 108, network 112, and network devices 114, 116, and 118. In other embodiments, system 100 may include additional components and/or may not include all of the components listed above.

System 100 may be used for interacting with people one or more of a number of different types of ways. For example, system 100 may be used for online marketing, advertising, and/or networking.

Sign 102 may designate a product as being for sale. Sign 102 may display a variety of information, such as one or more codes that are used to match the sign with a listing on a website. The one or more codes may contain a portion representing geographic information. Sign 102 may be made from any of a variety of materials such as metal, plastic, cardboard, paper, wood, glass, and/or fiberglass. The one or more codes, images, and/or other messages on sign 102 may be added to sign 103 by any of a variety of methods, such as by molding, painting, embossing, and/or engraving sign 102. Sign 102 may be reusable. For example, sign 102 may be a static cling sign, and the user may use an erasable sharpie pen to write information (e.g., the one or more codes) on sign 102. In other embodiments, other types of erasable writing and other types of signs may be used, such as a marker that can be wiped off sign 102. Alternatively, the user may place on sign 102 removable labels and/or old labels may be covered by new labels, without removing the old labels. The user may then change the information on sign 102 (e.g., by erasing and/or covering the old information), without ordering another sign, for using sign 102 for selling a different product. In another embodiment, sign 102 is not reusable.

A seller may order the sign 102 in a manner that will be discussed in conjunction with FIGS. 3 and 9-11. Sign 102 may be used for advertising more than one item, for networking, or as part of a verification process that may be independent of any specific product being advertised, as will be discussed below in conjunction with FIGS. 3, 9, and 10. A potential buyer sees sign 102 and may contact a potential seller via system 100. Sign 102 will be discussed further in conjunction with FIGS. 3-6 and 9-11.

Website host 104 may include software for interacting with a network, hosting a website, and/or a database. Website host 104 may be used for updating and/or managing a website, which may be used for displaying information related to the product associated with sign 102. Input device 106 and output device 108 will be discussed in conjunction with FIG. 2. Although in the example of FIG. 1 website host 104 is depicted as one machine, website host 104 may also be a system of several machines, which may or may not be linked as a network.

Network 112 may be used to access a website associated with website host 104. Network 112 may be any one of or any combination of one or more Local Area Networks (LANs), Wide Area Networks (WANs) (e.g., an Internet or intranet), phone networks, wireless networks, and/or other networks.

Each of network devices 114, 116, and 118 may be any device that is capable of accessing a network, such as a computer, a computer terminal, a telephone, a cell phone, a network appliance, and/or other network device. Although only three network devices are illustrated, there may be any number of network devices. Any of the network devices may be of a different or the same type of network device as any other network device.

FIG. 2 shows a block diagram of a machine 200 used in FIG. 1. Machine 200 may include output system 202, input system 204, memory system 206, processor system 208, communications system 212, and input/output device 214. In other embodiments, machine 200 may include additional components and/or may not include all of the components listed above.

Machine 200 is an example of a computer that may be used for any of website host 104, and/or Internet devices 114, 116, and/or 118.

Output system 202 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or Internet, for example. Output device 108 is an example of output system 202.

Input system 204 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or Internet (e.g., IrDA, USB), for example. Input device 106 is an example of input system 204.

Memory system 206 may include, for example, any one of, some of, any combination of, or all of a long term storage system such as a hard drive, a short term storage system such as random access memory, a removable storage system such as a floppy drive or a removable drive, and/or flash memory. Memory system 206 may include one or more machine-readable mediums that may store a variety of different types of information. The term machine-readable medium is used to refer to any medium capable of carrying information that is readable by a machine. One example of a machine-readable medium is a computer-readable medium. Another example of a machine-readable medium is paper having holes that are detected that trigger different mechanical, electrical, and/or logic responses. The term machine-readable medium also includes mediums that carry information while the information that is in transit from one location to another, such as copper wire and/or optical fiber.

Processor system 208 may include any one of, some of, any combination of, or all of multiple parallel processors, a single processor, a system of processors having one or more central processors and/or one or more specialized processors dedicated to specific tasks.

Communications system 212 communicatively links output system 202, input system 204, memory system 206, processor system 208, and/or input/output system 214 to each other. Communications system 212 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 214 may include devices that have the dual function as input and output devices. For example, input/output system 214 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 214 is optional, and may be used in addition to or in place of output system 202 and/or input device 204.

FIG. 3 shows an example of memory system 206 of website host 104 for an embodiment in which website host 104 is machine 200. Memory system 206 may store Graphical User Interface (GUI) 302, which may include registration forms 304. Registration forms 306 may include geographic location 306. Memory 206 may also store verification software 308, which may include online verification 310, offline verification 312, and display sign verification 314. Memory 206 may also store listings 316, advertising process 320 and purchasing process 322. In other embodiments, memory system 206 may not have all of the components listed above and/or may have other components in addition to or instead of those listed above.

GUI 302 includes the images and forms presented to a user of a website associated with website host 104. GUI 302 may present registration forms to a user of the website when the user decides to join. A user is anyone that visits the website associated with website host 104. Some examples of users that may be associated with an auction website are buyers, sellers, and those paying for an advertisement. In an embodiment, after completing a registration process, filling out some forms, and/or verifying the user's identity, the user becomes a member. In an embodiment, only members may participate in the selling, advertising, viewing, and/or buying of a good or service. The term user is generic to the term member. GUI 302 may present a series of one or more images to the user that query the user in order to verify (e.g., establish) an identity and a level of confidence that the identity is accurate. GUI 302 may also present various pages related to viewing information about products being sold, purchasing a product, buying a product, and viewing information about a buyer and/or a seller.

Forms 304 include the images that are presented to the user, which may include a variety of directions for the user to follow in order to register (thereby becoming members), verify an identity, and/or collect other information by filling in a variety of fields.

Geographic location 306 may be one or more fields and/or one or more forms within forms 304 for collecting information related to the geographical location of the user. The geographic location of the users may be obtained by requesting that the user fill out a form as part of the registration, verification, and/or other process.

Verification software 308 may verify the information obtained from the member and/or may verify information given by a member in order to log onto the website. In this specification, the term verify and the conjugations of verify are generic to identify and register and the corresponding conjugations of identify and register. In this specification, the word identify or register or a conjugation of identify or register may be substituted for verify or the corresponding conjugation of verify to obtain a specific embodiment. Verification software 308 may interact with GUI 302 to perform various tasks requested by a user via GUI 302. Verification software 308 may cause various forms associated with forms 304 to be presented to a user for the user to fill in.

There are several methods of verifying the identity of a user, which may be incorporated into verification software 308 as separate stages and/or as different options. During the verification process, the identities of users are verified. The identity of users may be established by one or more verification processes. The verification process may include an offline verification, online verification, display sign verification and/or other verification processes. The registration may be a part of the verification, and may include the filing out of the form, prior to verifying any content. A user of the system may be required or may be given a choice, via verification software 308, to use one or more of several software components associated with different forms of verification. The software components may include but are not limited to, online verification 310, offline verification 312, and/or the display sign verification 314.

Verification software 308 may have various levels (e.g., degrees) of authenticity (e.g., trust) that are assigned to a user to indicate a confidence level that the user is trust worthy. The degree of trust assigned to the user may depend on which of the methods of verification the user implemented and the nature of the information obtained about the user as part of the verification processes that the user implemented. Any part of, or all of, verification software 308 may be used as part of a registration process.

Online verification 310 is software related to the online verification 310 method of verifying the identity of users (e.g., members of a website or other users), which may involve the user filling out one or more forms associated with forms 304. During online verification 310 the user may provide various forms of identify information, such as name, address, social security number, credit card information, employment information, and/or other forms of identification information. Online verification 310 may perform a comparison of information supplied by the user with information available from a variety of sources, such as public records, banks, credit card companies, government agencies, and/or credit bureaus. In an embodiment, online verification 310 may be part of a registration process for registering new members or is invoked by a registration process. Alternatively, online verification 310 may include within it a registration process as opposed to being included within the registration process.

Offline verification 312 is software related to another method of verifying the identity of users (e.g., members of a website or other users), which involves using one or more website personnel to verify the identity of a user in an in-person (e.g., face-to-face) meeting. The one or more website personnel may be the owner of the website and/or various other website personnel, for example. During the in-person meeting the identification process may include interviewing the user, asking for specific information, photographing the user, taking the user's fingerprints, examining a photo ID of the user, and/or asking the user to provide information via a filling out one or more forms. The specific information may include identification information, such as driver's license or auto insurance information, for example. The forms may be on paper and filled out by hand, may be entered into website host 104, and/or entered into another computer associated with website host 104, which may be at the premises of website host 104. The information gathered by the website personnel may be entered into a system associated with website host 104 via verification software 308.

The in-person meeting may be conducted instead of or in addition to the online verification 310. Whether or not the online verification is also conducted, the information gathered during the offline identification may be completely the same, partially the same, or different than the information gathered during the online verification 310 (if conducted) or that would have been gathered during the online verification 310 (if not conducted).

Display sign verification 314 is software associated with another method of verifying the identity of a user, which may be offered via verification software 308. In an embodiment, verification software 308, via display sign verification 314, is used to verify the geographic location of a product and/or seller via display signs, such as sign 102, which are sent to the seller. During display sign verification 314, members may receive sign 102 for verifying the member's geographic location. The display sign may be ordered in conjunction with online verification 310 or may be ordered in conjunction with an offline verification. Display sign verification 314 may include instructions and/or forms associated with forms 304 for ordering a display sign. Display sign verification 314 may cause dialogue boxes associated with GUI 302 to be displayed for choosing whether to schedule an in-person verification and for scheduling the verification. The geographic information portion of the code used by display sign verification 314 may be based on information provided by the user via geographic location 306 of forms 304. The geographic information portion may be associated with a predefined geographical zone system and an identification process, which provides a more secure and trusted website service, resulting with credentialed users hosted by the website. A potential buyer sees the sign, and uses the code or codes listed on the sign to find on the website more information about the product and/or seller.

Sign 102 may be ordered as part of display sign verification 314 without having any specific product associated with sign 102, but may be ordered instead for the purpose of verifying the information associated with the user. Later when there is a product that user wants to sell, the user may advertise the product by placing the sign within a vicinity of the product such that a passerby will associate the sign with the product. Sign 102 may be used for providing a passerby a means of contacting the user regardless of whether the product advertised is an item for sale. For example, sign 102 may be used for networking or facilitating meeting other people, in which case the product advertised is the owner of sign 102. Alternatively, display sign verification 314 may be used to order sign 102 for the purpose of advertising that a specific product is for sale.

Display sign verification 314 may generate a confirmation code, which is sent with sign 102 to the user that ordered sign 102. Upon receipt of sign 102, the user may enter the confirmation code via GUI 302. Receipt of the confirmation code at website host 140 may be a required step for activating a listing. Alternatively, the confirmation code may not be required to activate a listing, but which level of authentication is assigned to the user may be partially or completely dependent upon receipt of the confirmation code. In another embodiment, confirmation codes are not used.

Any of a number of types of methods for distributing signs, such as sign 102, may be used. In an embodiment, the sign 102 is sent via priority mail. A user's geographic location may be verified via sending sign 102 to the address given by the user as their address. For example, if during display sign verification 314, the user gives someone else's address or a nonexistent address, the postal service is likely to return sign 102, stamped with no such address or no such person at this address. Thus, not having sign 102 returned as a result of the sign being sent to an incorrect address forms a verification that the address is authentic.

The display sign verification 314 may be used instead of or in conjunction with the offline verification 310 and/or an in-person meeting. Alternatively, offline verification 314 and/or an in-person meeting may be used without the display sign verification 314. In an embodiment, a user needs to only complete any one of online verification 310, display sign verification 314, and an in-person meeting to become a member. In one embodiment, the verification method is the user's choice, while in another embodiment there is one specific verification method (e.g., online verification) that is required and the other two are optional. The user may then have the option to complete one or both of the other verification processes to obtain a higher level of authentication. Alternatively, there may be two verification methods that are required for membership, which in one embodiment are a specific two and in another embodiment are chosen by the user. The remaining verification method is optional and may be performed to increase the level of authentication of the user. In yet another embodiment, all three methods of verification are required for membership.

Listing 316 is a listing of members and/or items that are being traded. Listing 316 may also include software for adding, removing, and/or editing a listing of a member and/or a product. In an embodiment, in order to activate a listing associated with listing 316, a confirmation code may need to be received culminating a display sign verification 314. In another embodiment, the confirmation code is only necessary is a display sign verification 314 is chosen, but display sign verification 314 is optional. In another embodiment, activating a listing associated with listing 314 may require a specified level of authentication, but may not necessarily require display sign verification 314 and/or the confirmation code. In another embodiment, listing 316 may be activated regardless of the level of authentication. However, a rating may be assigned to the user associated with the listing, which is dependent on the level of authentication.

Advertising process 320 may include ordering a display sign, and may invoke display sign verification 314. During the advertising process 320, software associated with listing 316 may be called for placing the product in a listing on a website. As part of the listing process, a physical display sign may be sent to the seller, if the seller decided to use of display sign identification. The user may be offered a choice of when to activate the listing. Advertising process 320 is discussed further in conjunction with FIGS. 10 and 11.

Purchasing process 322 is used for purchasing a product listed in list 316. Purchasing process 322 may include identifying a product listed based on a code that has a portion representing information obtained from geographic location 304.

FIG. 4 shows an example of a display sign 400. Display sign 400 may include message 404 and code 406. In other embodiments, display sign 400 may not have all of the components listed above and/or may have other components in addition to or instead of those listed above.

Sign 400 is one example of sign 102. Message 404 may indicate that the product is for sale, may contain contact information, may contain other information about the product, may contain information about where to find more information related to the product or the advertisers, and/or other information. For example, message 404 may be “FOR SALE.” As another example, message 404 may include two lines. The first line may be “FOR SALE,” and the second line may include a phone number.

Code 406 may be used to access information about the product and/or about the advertiser. A potential buyer may use one of network devices 114, 116, or 118 to access website host 104 via network 112. Then the potential buyer enters code 406 to find information about the product and/or the seller. The information about the product may be included in listing 316. Code 406 may include several parts, which are discussed in conjunction with FIG. 6A.

FIG. 5 shows another example of a display sign 500. Display sign 500 may include message 502, network address 504, code 506, and logo 508. In other embodiments, display sign 500 may not have all of the components listed above and/or may have other components in addition to or instead of those listed above.

Display sign 500 is another example of sign 102. In this example, message 502 is a text message that indicates the significance of network address 504, code 506, and/or logo 508. In the example of FIG. 5, message 502 is “VIEW AT.” However, message 502 may be replaced with any of a number of other messages, such as “FOR SALE,” “SEE AT,” and/or “GREAT BUY.”

Network address 504 may be any address, which may be associated with a network and which may be used to locate information about the item being advertised and/or the advertiser, such as a web address (e.g., a URL). In the example given the network address is www.areyouin.com. However, other network addresses may be used. Additionally network address 504 may be an address on a network other than the Internet in embodiments in which network 112 is not the Internet. For example, network address 504 may be an address on a LAN or a phone number of a location on a telephone network associated with website host 104. In other embodiment, other contact information may be provided in addition to, or instead of, network address 504.

Code 506 may be the same as code 406, which will be discussed in conjunction with FIG. 6A. Logo 508 may be a logo associated with website host 104 and/or a website and/or business associated with website host 104. By displaying logo 508, a buyer familiar with the website and/or business entity associate with website host 104 can more easily remember where to find the information that is of interest regarding the product being advertised. For example, a member of AreUN that sees sign 500 may have the AreUN web address already stored on one of network device 114-118 or may have already memorized the web address displayed, and therefore may not need to write down network address 504. Logo 508 may be replaced with any other identifier that will indicate where the information associated with the product advertised or the advertiser can be found. In an embodiment, signs 400 and 500 are purchased with the space for codes 406 and 506 left blank, and codes 406 and 506 are filled in at a later date. In another embodiment, codes 406 and 506 are filled in prior to purchase.

FIG. 6A shows an example of code 600. Code 600 may include zone portion 602, region portion 604, product information portion 606, and sequence portion 608. In other embodiments, display sign 600 may not have all of the components listed above and/or may have other components in addition to or instead of those listed above.

Code 600 is an example of a code that may be used for code 406 or 506. Zone portion 602 indicates a geographic location that is associated with the advertiser. The geographic location may have been obtained via geographic location 306 of forms 304. The geographic location associated with zone portion 602 may be of any size and may be of a size that is unrelated to the size of other zones. Alternatively, the size of the zones may be related to political and/or geographic boundaries. As another alternative, the size of the zones may be determined such that each zone has essentially the same size population, land area, number of members, and/or economic activity.

Region portion 604 is a portion of the code that indicates a geographic region. Similar to zone portion 602, the geographic location associated with region portion 604 may have been obtained via geographic location 306 of forms 304. The geographic location associated with region portion 604 may be any size and may be of a size that is unrelated to the size of other regions. Alternatively, the size of the regions may be related to political and/or geographic boundaries. As another alternative, the size of the regions may be determined such that each region has essentially the same size population, land area, number of members, and/or economic activity.

In one embodiment, each region may contain several zones. In one example, the regions are the states, and in the example of FIG. 6A the “CA” represents the state of California. However, in other embodiments, the locations associated with regions may be unrelated to the locations associated with the states. In another embodiment, each region overlaps several zones and each zone may overlap several regions. Consequently, although both the region and zone may be large areas of land, the locality where a specific zone and a specific region overlap may be a much smaller locality than a locality that encompasses the entire region or the entire zone. In other embodiments, zones may be further subdivided into smaller localities and/or regions may become subdivisions of larger localities.

Product information portion 606 is a code that specifies the type of item being advertised. Depending on the type of product, product information portions 606 may have different meanings. For example, for some types of products the first digit may indicate a category and the second digit may indicate a subcategory, while for other types of products all of the products have the same product information portion 606. In one example, if the first digit is a 1, the product is a vegetable, and if the second digit is a 3, the vegetable is green and leafy. In another example, all cars have a product information code of 40, while product information codes 83-97 refer to different types of airplanes. If sign 102 is ordered prior to associating sign 102 with a product, a special product information code may be assigned that indicates that the product was not associated with the sign at the time that the sign was purchased. Alternatively, if the sign is ordered prior to associating sign 102 with a product, product information portion 606 may be absent from code 600.

Sequence portion 608 may be a sequence number that numbers which item is being advertised. The sequence numbers may be assigned in chronological order and may uniquely identify each product being advertised. In other words, no two products have the same sequence number. In another example, the sequence numbers uniquely identify each product of a particular category and/or geographic location. Thus in this example, two products from two different categories may have the same sequence number, but not two products within the same category. In yet another example, sequence numbers for each user are unique. In this example, the two products being sold by two different users may have the same sequence number, but two products sold by the same user will always have different sequence numbers.

Although in FIG. 6A, the zone portion 602, region portion 604, and product information portion 606 are each two digits and the sequence portion 608 is four digits, the number of digits included in each portion may be any number. Although in the example of FIG. 6, numbers are used for zone portion 602, product information portion 606, and sequence portion 608, while letters are used for region portion 604, any alphanumeric or other character may be used for any part of code 600.

In an embodiment, system 100 may be associated with a property identification system, and code 600 may be based upon the property identification system. A virtual Internet property identification system may be included to provide a uniform system of identifying and allocating the virtual properties. In one embodiment, the virtual properties are identified as online cities or towns that approximate geographic locations from which online auction activities may originate. Each virtual Internet property may be associated with a physical location such as a particular city or region of the country that an interested individual may be familiar with. In various embodiments, virtual Internet properties may be referred to as being part of, or corresponding to a place, municipality, capital, megalopolis, metropolis, suburb, county seat, trading center, inner city, downtown, shopping center, district, business or financial district, incorporated town, village, metropolitan area, township, port, civic, community, municipal, an urban area, a small collection of dwellings, hamlet, or other locations describing a populated area where auction related activities may originate from.

In other embodiments, these virtual properties may be associated with actual cities or towns that can be described by characteristics including zip code, location, and population, among other distinguishing characteristics. For example, the zip codes designated by the postal service of each country may be used as an identifier for individual virtual Internet properties. Moreover, the boundaries between virtual Internet properties may be correlated with the geographic boundaries defined by the zip codes. As such, each virtual Internet property in the United States may be represented by a numerical value such as a five or a nine digit zip code that is used by the U.S. Postal Service to designate the particular geographic area with which the virtual property is associated. Additionally, some virtual properties may be identified by a single zip code while others may be identified by a plurality of zip codes that delineate the boundaries of the virtual property area. Code 600 may be based on the identifiers used for the virtual properties that correspond to geographic locations. Virtual Internet properties are discussed in US Patent Application, Publication Number 20030105705. The systems and methods discussed in US Patent Application, Publication Number 20030105705 may be used in conjunction with systems and methods discussed in the present specification. The contents of US Patent Application, Publication Number 20030105705, are incorporated herein by reference.

FIG. 6B shows a first example of a combination of a product and sign. FIG. 6B shows a house 612 and a sign 614 having code 618, which includes product information 619A and sequence portion 619B.

FIG. 6C shows a second example of a combination of a product and sign. FIG. 6C shows a mug 620 and a sign 622 having code 624, which includes product information 625A and sequence portion 625B.

FIG. 6D shows a third example of a combination of a product and sign. FIG. 6B shows a pencil 626 and a sign 628 having code 630, which includes product information 631A and sequence portion 631B.

FIGS. 6B-D show different products being advertised via signs. Each of signs has a different code. Codes 618, 624, and 630 differ from one another in the sequence portions 619B, 625B, and 631B and product information portion 619A, 625A, and 631A. The sequence portions 619B, 625B, and 631B differ from one another, so that each code is unique. The product information portions 619A, 625A, and 631A differ from one another, because the products associated with each of codes 618, 624, and 630 are different.

FIG. 7 shows an example of geographic location 306. Geographic location 306 may include street fields 702, city field 704, state field 706, and zip code field 708. In other embodiments, geographic location 306 may not have all of the fields listed above and/or may have other fields in addition to or instead of those listed above. Street fields 702, city field 704, state field 706, and zip code field 708 are for entering the street address, the name of the city, the name of the state and the zip code, respectively, that are included in the address of an applicant. Optionally, there may also be a field for entering the name of the country where the user lives.

FIG. 8 is a method 800 of purchasing an item using system 100. Method 800 is an example of a process that may be performed in conjunction with purchasing process 322. Purchasing process 322 may be the portion of method 800 that is performed by software. In step 802, a buyer sees sign 500 having code 600. If the buyer is a member or a frequent user of the network listed on sign 500, the buyer recognizes the logo 508 and does not need to write down the network address 504, because the buyer knows web address by heart or already has network address 504 recorded as a result of one or more prior uses of the website. If the buyer is new, the buyer records the web address. Additionally, the buyer records code 600. In step 804, the buyer logs on to the website associated with website host 104 using one of network devices 114-118. The buyer either enters code 600 into a field on the website or looks up code 600 on a list of codes. Based on code 600, the buyer finds the listing for the products advertised, and decides whether to buy the product. In step 806, the buyer contacts the seller regarding purchasing the product. Contacting the seller may involve placing a bid online for the product, visiting the premises of the seller, and/or telephoning the seller. After step 806, method 800 may terminate. In other embodiments, method 800 may not have all of the steps listed above or may have other steps instead of or in addition to those listed above.

FIG. 9 shows a flowchart of an example of a method 900 of verifying (e.g., registering) a user. Method 900 is an example of a method that may be performed in conjunction with verification software 308. Verification software 308 may be the software that performs the portion of method 800 that is performed by website host 104. In step 902, an online registration is performed by having the user fill out forms 304, which may include step 904 in which the user conveys geographic location information. In step 906, the user decides whether to have an in-person verification. If the user decides to have an in-person verification, the method proceeds to step 907, during which the in-person meeting is conducted. After step 907, method 900 proceeds to step 908. Returning to step 906, if the user decides not to have the in-person meeting, method 900 proceeds directly from step 906 to 908. In step 908, a decision is made whether to order a sign. If a decision is made to order a sign, method 900 proceeds to step 910 where the sign is ordered. Ordering the sign may initiate a display sign verification. In an embodiment, as part of step 910, a confirmation code may be generated and sent with the sign to the one ordering the sign. Returning to step 908, if a decision is made not to order the sign, method 900 terminates after step 908. Steps 902, 906, and 908 may be performed in any order with respect to one another. Step 902 could be made optional and steps 907 and/or 910 could be made to be required, thereby eliminating the need for steps 906 and/or 908, respectively. In step 912, a waiting period is started. The waiting period is long enough to allow a response to mailing sign 102 to be received. The response may be a confirmation that the sign 102 was received, or the return of sign 102 as a result of sign 102 being sent to a nonexistent address or to an address that does not correspond to the user that ordered sign 102, or another indication that the sign was sent to an incorrect address. As an example of a confirmation that the sign was received, in one embodiment, when the user receives he sign, the user logs in to the website and activates the listing for the item. In an embodiment, in order to activate the listing, the user may need to enter the confirmation code into GUI 302. After the waiting period ends or after receipt of one of the responses, method 900 proceeds to step 914. In step 914, a determination is made as to whether the waiting period ended without receiving a response or if a response was received; a determination is made as to which type of response was received. In step 916, a determination is made as to a level of authenticity based on results of steps 902, 907, and/or 914. In one embodiment, there are only two levels of authentication, which are authenticated or not authenticated. In an embodiment, if the user is not authenticated, the user's listing cannot be activated. For example, in one embodiment, step 916 is implemented by either activating the user's listing when the user enters the confirmation code, or else the user's listing is not activated, because the confirmation code has not been entered. In another embodiment, there may be multiple levels of authentication, and which one is assigned to the user may be at least partially based on whether or not the confirmation code was received. In yet another embodiment, there is no confirmation code. Steps 912-916 may be performed any time after step 910. In other embodiments, method 900 may not have all of the steps listed above or may have other steps instead of or in addition to those listed above.

FIG. 10 shows a flowchart of an example of a method 1000 for advertising a product. In step 1002, the user enters information about the product, such as pricing information, information related to the age, condition, make, and model of the product. In step 1004, the user decides whether to purchase sign 102. If the user decides to order sign 102, method 1000 proceeds to step 1006 where sign 102 is ordered. Ordering sign 102 may involve specifying characteristics of sign 102, such as the color and the size of sign 102. Ordering sign 102 may also involve deciding on a method of delivery. Optionally, ordering sign 102 may initiate a display sign verification (e.g., if a display sign verification was not already performed), which may involve steps 912, 914, and/or 916 of method 900. After step 1006, method 1000 proceeds to step 1008. Returning to step 1004, if the user decides not to order the sign, method 1000 proceeds directly from step 1004 to step 1008. In step 1008, the time and/or date when the listing should first appear are decided upon. Alternatively, the user may decide not to display the listing and decide not to specify a later date when the listing will be displayed. Then at a later date the user may choose to activate the listing so that it is displayed. Optionally, the user may be able to customize the listing. Optionally, method 1000 may include step 1010 for viewing the listing after the listing is created, and deciding whether the information and/or appearance of the listing is desirable or needs improvement. Then in optional step 1012 the user may edit the listing based on viewing the listing. Next, method 1000 terminates. In other embodiments, method 1000 may not have all of the steps listed above or may have other steps instead of or in addition to those listed above.

FIG. 11 shows a flowchart of a method 1100, which is an example of method 900 applied to selling cars. In step 1102, the user enters information about the type of car being sold (e.g., the make and model). In step 1104, the user enters detailed information about the car, such as pricing information, mileage, ownership history, and/or whether or not the vehicle was inspected. The pricing information may allow the user to choose whether to request a fixed price or whether to accept different bids for the vehicle. If the price is not fixed there may be a field for entering a minimum that the seller is willing to accept. In step 1106, the user uploads photos of the car and/or copies of other documents associated with the vehicle such as copies of receipts for maintenance performed on the car. In step 1108, the user orders a sign, and decides when to activate listing 310 for the car. Depending on the method of delivery of the sign, the user may decide to delay activating the listing for the car. Alternatively, the user may be capable of entering the site at a later date to activate the listing. The user may also be capable of viewing and editing the listing prior to activating the listing. After step 1108, method 1100 terminates. Steps 1102-1108 may be performed in any order. In other embodiments, method 1100 may not have all of the steps listed above or may have other steps instead of or in addition to those listed above.

In this specification, a number of embodiments are described for each element and method step. In general, any of the embodiments of a given element or method step may be used with any of the embodiments of the other elements and/or other method steps.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A system comprising:
a sign including at least
a web address, and
a code that identifies a product having at least two portions, wherein each portion represents a different type of information.

2. The system of claim 1, wherein the sign also includes at least a logo associated with the web address.

3. The system of claim 1, wherein the at least two portions include at least a product information portion representing information about the product, and a sequence portion corresponding to the sign.

4. The system of claim 1, further comprising a machine readable medium storing one or more instructions for a method including at least
receiving a request for the sign.

5. The system of claim 1, further comprising a machine readable medium storing one or more including at least
a list including at least a listing for the product.

6. The system of claim 1, further comprising a machine readable medium storing one or more instructions for a method including at least
processing information that is used for sending the sign.

7. The system of claim 1, further comprising a machine readable medium storing one or more instructions for a method including at least
transmitting information that causes one or more web pages to be displayed by at least
transmitting information causing forms for an online verification to be displayed;
transmitting information causing information about initiating an offline verification to be displayed; and
transmitting information for causing to be displayed forms for ordering a sign and
initiating a display sign verification.

8. The system of claim 1,
(I) wherein the sign also includes at least a logo associated with the web address;
(II) wherein the at least two portions includes at least
(A) a location portion representing the location,
(B) a product information portion representing information about the product associated with the code, and
(C) a sequence portion having a sequence number corresponding to the sign;
(III) the system further comprising:
(A) a machine associated with a website, the machine including at least
(1) a processor, and
(2) a machine-readable medium communicatively coupled to the processor;
the machine-readable medium storing thereon
(a) the code,
(b) a listing having information related to the product, the listing being stored in association with the code,
(c) one or more forms for gathering information from a user, and
(d) one or more instructions for causing the processor to implement a method including at least
(i) causing the one or more forms to be displayed on a machine of the user;
(ii) receiving form information from the user based on the forms, the receiving including at least
receiving geographic information related to the location,
receiving online verification information associated with the user, and
receiving scheduling information related to scheduling an in-person meeting for conducting an offline verification;
(iii) generating the code based at least in-part on the geographic information;
(iv) processing the scheduling information for initiating the scheduling;
(v) sending messages indicating to at least
generate the sign having at least the code and contact information;
physically send the sign to the physical location based on the geographic location; and
wait a period of time to determine whether one or more events occur or do not occur in response to sending the sign;
(vi) determining a level of authenticity based at least on
whether the one or more events occur or do not occur after the sign is sent to the physical location,
the online verification information, and
offline verification information gathered during the in-person meeting;
(vii) receiving from the user product information related to the product;
(viii) associating the product with the code;
(ix) receiving a request to list the product at the web address;
(x) creating the listing;
(xi) receiving the code;
(xii) sending listing information based on the listing in response to receiving the code;
(xiii) receiving a request to buy the product; and
(xiv) initiating a sale based on the request;
(xv) wherein the method is capable of performing the determining prior to the associating of the product with the code.

9. A system comprising a machine readable medium storing a code having at least
a portion indicating product information associated with a product;
a portion indicating a geographic location associated with the product; and
a sequence number associated with the product.

10. The system of claim 9, wherein the machine readable medium also stores a listing within which the product is listed in conjunction with the code.

11. The system of claim 10, wherein the machine readable medium also stores one or more instruction for implementing a method comprising:
receiving the code; and
presenting the listing in response to receiving the code.

12. A method comprising:
determining a level of authenticity based at least on whether one or more events occur or do not occur as a result of a physical sign being sent to a physical location.

13. The method of claim 12, further comprising receiving confirmation that the physical sign was received, and wherein the receiving is one of the one or more events.

14. The method of claim 12, further comprising receiving an indication that the physical sign was sent to an address that does not correspond to a user that ordered the physical sign, and wherein the receiving is one of the one or more events

15. The method of claim 12, further comprising:
sending signals to a user including information that causes one or more forms to be displayed,
receiving form information from the user based on the one or more forms presented, and
wherein the determining is also based on verification information received.

16. The method of claim 15, wherein the verification information includes at least part of the form information.

17. The method of claim 15, comprising initiating a scheduling of an in-person meeting with the user, the initiating being based at least in-part of the form information; wherein the verification information includes at least some information gathered during the in-person meeting.

18. The method of claim 12, wherein the determining is made prior to associating the physical sign with a specific product.

19. The method of claim 12, further comprising:
causing one or more forms to be displayed on a machine of a user;
receiving form information from a user based on the forms, the receiving including at least
receiving geographic information related to a geographic location associated with the user,
receiving online verification information associated with the user, and
receiving scheduling information related to scheduling an in-person meeting for conducting an offline verification;
generating a code based on the geographic information;
processing the scheduling information for initiating the scheduling;
generating the physical sign having at least the code and contact information;
sending the physical sign to a physical location based on the geographic information;
waiting a period of time to determine whether certain events occur or do not occur in response to sending the physical sign;
receiving product information related to a product for sale from the user;
associating the product with the code;
receiving a request to list the product on a website associated with the forms;
creating a listing of the product on the website in response to the request to list;
receiving the code;
sending listing information based on the listing in response to receiving the code;
receiving a request to buy the product; and
initiating a sale based on the request;
wherein the determining of the level is also based on the online verification information and offline verification information collected during the offline verification; and
wherein the method is capable of performing the determining prior to the associating of the product with the code.
